(19) United States
(12) Patent Application Publication
(10) Pub. No.: US 2013/0143123 A1
(43) Pub. Date: Jun. 6, 2013

(54) MESOPOROUS METAL PHOSPHATE MATERIALS FOR ENERGY STORAGE APPLICATION

(71) Applicants: Palani Balaya, Singapore (SG); Saravanan Kuppan, Singapore (SG); Hwang Sheng Lee, Singapore (SG); Ananthanarayanan Krishnamoorthy, Singapore (SG)

(72) Inventors: Palani Balaya, Singapore (SG); Saravanan Kuppan, Singapore (SG); Hwang Sheng Lee, Singapore (SG); Ananthanarayanan Krishnamoorthy, Singapore (SG)

(73) Assignee: National University of Singapore, Singapore (SG)

(21) Appl. No.: 13/817,929

(22) PCT Filed: Aug. 19, 2011
(86) PCT No.: PCT/SG2011/000285

§ 371 Date: Feb. 20, 2013

Related U.S. Application Data
(60) Provisional application No. 61/401,855, filed on Aug. 20, 2010.
(60) Provisional application No. 61/501,341, filed on Jun. 27, 2011.

(51) Int. Cl. H01M 4/133

(52) U.S. Cl. CPC H01M 4/133
USPC 429/221; 252/182.1; 429/231.2

(57) ABSTRACT

Mesoporous particles each including LiFePO₄ or Li₃V₂(PO₄)₃ crystallites and uniform coating of amorphous carbon on the surface of each of the crystallites. The crystallites have a size of 20-50 nm and the carbon coating has an average thickness of 2-7 nm. Also disclosed is a soft-template method of preparing the above-described mesoporous particles and the use of these mesoporous particles in lithium batteries.

### BACKGROUND OF THE INVENTION

Lithium batteries present one of the most important approaches to mobile power. They can transfer chemical energy reversibly by homogeneous intercalation and de-intercalation reaction without significant structural changes.

Recently, lithium iron phosphate and lithium vanadium phosphate have been explored as promising cathode materials. They possess many advantages: (a) high operating flat voltage (about 3.5 V vs Li⁺/Li) and high theoretical capacity (ca. 170 mA h g⁻¹ for LiFePO4 and 197 mAh. g⁻¹ for Li₃V₂(PO₄)₃), (b) easy synthesis, (c) excellent electrochemical stability, (d) low cost, and (e) environmentally benign materials as compared to the toxic conventional cathode material LiCoO₂.

The key problem of using LiFePO₄/Li₃V₂(PO₄)₃ in batteries is their sluggish mass and charge transport, which causes capacity loss when the current density is increased. Many attempts have been made to improve the ionic diffusion by reducing the crystallite size of LiFePO₄/Li₃V₂(PO₄)₃ and to improve electronic conduction by coating the surface using conductive carbon. Yet, there is still a need to develop more economic and more efficient LiFePO₄/Li₃V₂(PO₄)₃ for use in lithium batteries.

### SUMMARY OF THE INVENTION

This invention is based on a discovery of mesoporous LiFePO₄/C and Li₃V₂(PO₄)₃/C particles prepared by a soft-template method.

One aspect of this invention relates to a mesoporous particle, which includes LiFePO₄ or Li₃V₂(PO₄)₃ crystallites and uniform coating of amorphous carbon on the surface of each of the crystallites. Each of the crystallites has a size of 20-50 nm and the carbon coating has an average thickness of 2-7 nm. The crystallites are packed in such a manner that they are in close contact with their adjacent crystallites, resulting in mesopores (i.e., nanosized pores, such as 2-10 nm) in the particle.

In one embodiment, the mesoporous particle includes LiFePO₄ crystallites. This particle may have one or more of the following features: the particle size is 100-2000 nm or 150-1000 nm, the particles are in plate-like or spherical shape, the carbon coating has an average thickness of 5 nm, and the crystallite size is 20-30 nm.

In another embodiment, the mesoporous particle includes Li₃V₂(PO₄)₃ (or α-Li₃V₂(PO₄)₃) crystallites. This particle may have one or more of the following features: the particle size is 100-2000 nm or 150-1000 nm, the carbon coating has an average thickness of 5 nm, and the crystallite size is 20-30 nm.

Another aspect of this invention relates to a method of preparing carbon-coated mesoporous metal phosphate particles. The method includes (i) providing a solution containing a carbon-containing soft-template molecule, a lithium ion-containing compound, an iron or vanadium ion-containing compound, a phosphate ion-containing compound, and a solvent; (ii) removing the solvent to afford a solid mixture; and (iii) sintering the solid mixture to provide carbon-coated mesoporous metal phosphate particles. The lithium ion-containing compound, the iron or vanadium ion-containing compound, and the phosphate ion-containing compound used in step (i) can be different, i.e., three different compounds. Alternatively, two or three of them are the same compound. For example, lithium dihydrogen phosphate is both a lithium ion-containing compound and a phosphate ion-containing compound.

Still another aspect of this invention relates to a battery, which includes an anode, a cathode, and a non-aqueous electrolyte between the anode and the cathode. The cathode of this battery contains the particles described above.

The details of one or more embodiments of the invention are set forth in the description and drawings below. Other features, objects, and advantages of the invention will be apparent from the detailed description of several embodiments and also from the appending claims.

### BRIEF DESCRIPTION OF DRAWINGS

FIG. 1 shows the diffraction patterns of LiFePO₄ and α-Li₃V₂(PO₄) and the identification of Bragg planes.

FIGS. 2 (a) and (b) show FESEM images of LiFePO₄/C, (c)-(d) are FESEM images of Li₃V₂(PO₄)₃/C, and (e) is an HRTEM image of the carbon coating on the surface of Li₃V₂(PO₄)₃.

FIG. 3 shows a charge-discharged voltage curve for LiFePO₄/C at C/10 (17 mA/g) rate in the voltage range of 2.3-4.6 V.

FIG. 4 shows charge-discharge curves of LiFePO₄/C cathode materials at various C rates (from C/10 to 30 C) in the voltage range of 2.3-4.6 V.

FIG. 5 shows a charge-discharged voltage curve for α-Li₃V₂(PO₄)₃ at C/10 (19.7 mAh/g) rate in the voltage range of 2.5-4.6 V.

FIG. 6 shows charge-discharge curves of monoclinic α-Li₃V₂(PO₄)₃/C cathode materials at various C rates (from C/10 to 80 C) in the voltage range of 2.5-4.6 V.

FIG. 7 illustrates a rate performance of α-Li₃V₂(PO₄)₃/C versus Li cell up to 25 cycles in the voltage range of 2.5-4.6 V.

FIG. 8 shows a cyclic performance of α-Li₃V₂(PO₄)₃/C versus Li cell at 20 C up to 1000 cycles in the voltage range of 2.5V-4.6 V.

### DETAILED DESCRIPTION OF THE INVENTION

This invention relates to mesoporous nanostructured LiFePO₄/C and Li₃V₂(PO₄)₃/C particles as described above.

To synthesize the mesoporous particles of this invention, one first mixes a soft-template molecule, a lithium ion-containing compound, a iron or vanadium ion-containing compound, a phosphate ion-containing compound, and a solvent at a predetermined weight ratio to form a solution. The lithium ion-containing compound, the iron or vanadium ion-containing compound, the phosphate ion-containing compound are the sources for the lithium ions, the iron or vanadium ions, and the phosphate ions included in the mesoporous particles. They are preferably at a stoichiometric ratio in the solution.

The solution is stirred at a predetermined temperature (e.g., room temperature or an elevated temperature) for adequate duration to allow the formation of soft-template molecule-coated LiFePO₄/Li₃V₂(PO₄)₃ nanocrystals. Without being bound by theory, the mechanism for forming the nanocrystals is described below.

In the solvent, the soft-template molecules, usually carbon-containing surfactants, self-assemble into micelles at its critical micellar concentration. At the same time, the compounds containing lithium, iron/vanadium, and phosphate ions are reacted to form LiFePO₄/Li₃V₂(PO₄)₃. The mesophase structures of the micelles provide micro or meso pores for, and guide, the growth of LiFePO₄/Li₃V₂(PO₄)₃ nanocrystals. As such, the micelles restrict the LiFePO₄/Li₃V₂(PO₄)₃ nanocrystals from overgrowth. Generally, the aspect ratio of the nanocrystals is decided by the morphology and sizes of the micelles. The reactant concentration and the surfactant concentration also play important roles in deciding the aspect ratio. See Yan et al., Rev. Adv. Mater. Sci. 24 (2010): 10-25.

The soft-template molecule used in this invention can be selected from various surfactants that provide suitable micelle morphology and size for growing LiFePO₄/Li₃V₂(PO₄)₃ nanocrystals. Examples of this molecule include, but are not limited to, octyl trimethyl ammonium bromide, decyl trimethyl ammonium bromide, dodecyl trimethyl ammonium bromide, myrsityl trimethyl ammonium bromide, cetyl trimethyl ammonium bromide, trimethyloctadecylammonium chloride, docosyltrimethylammonium chloride, pluronic P-123, pluronic F127, and pluronic F 68.

Sources of lithium ions include various ionic compounds of lithium. The lithium ion source can be provided in powder or particulate form. A wide range of such materials is well known in the field of inorganic chemistry. Non-limiting examples include, but are not limited to, lithium fluoride, lithium chloride, lithium bromide, lithium iodide, lithium acetate, lithium nitrate, lithium nitrite, lithium sulfate, lithium hydrogen sulfate, lithium sulfite, lithium bisulfite, lithium carbonate, lithium bicarbonate, lithium borate, lithium phosphate, lithium dihydrogen phosphate, lithium hydrogen ammonium phosphate, lithium dihydrogen ammonium phosphate, lithium silicate, lithium antimonate, lithium arsenate, lithium germinate, lithium oxide, lithium acetate, lithium oxalate, lithium hydroxide, and a mixture thereof. Hydrates of these compounds can also be used.

Sources of an iron ion and a vanadium ion include, but are not limited to, iron and vanadium fluorides, chlorides, bromides, iodides, acetates, acetyl acetonates, nitrates, nitrites, sulfates, hydrogen sulfates, sulfites, bisulfites, carbonates, bicarbonates, borates, phosphates, hydrogen ammonium phosphates, dihydrogen ammonium phosphates, oxide bis(2,4-pentanadionate), sulfate oxides, silicates, antimonates, arsenates, germanates, oxides, hydroxides, acetates, and oxalates. Hydrates of the above compounds can also be used. So can mixtures thereof. The iron and vanadium in the starting materials may have any oxidation state that is different from that of the desired products. Oxidizing or reducing conditions can be applied, as discussed below.

Sources of phosphate ions can be various phosphate salts. Examples include, but are not limited to, metal alkali metal phosphate, alkaline phosphate, transition metal phosphate, and non-metal phosphate, such as phosphoric acid, ammonium dihydrogen phosphate, ammonium hydrogen phosphate, ammonium phosphate, and a mixture thereof. Hydrates of these compounds can be used.

A compound containing two or all three of lithium, iron/vanadium, and phosphate ions can be used. For example, Li₃PO₄ may be used as a precursor to provide both Li and PO₄ ions, and VPO₄ may be used as a precursor to provide both V and PO₄ ions.

It is preferred to select sources with counterions that give rise to volatile by-products. Examples of such counterions are, for example, ammoniums, carbonates, oxides, and the like where possible.

The reaction between sources of lithium, iron/vanadium, and phosphate ions may also be carried out with reduction depending on the oxidation state of iron and vanadium ions in the corresponding source. For example, the reaction may be carried out in a reducing atmosphere such as hydrogen, ammonia, methane, or a mixture of reducing gases. Alternatively, the reduction may be carried out in-situ by including in the reaction mixture a reductant that will participate in the reaction to reduce one or more reaction components to the oxidation state of the component(s) required in the final reaction product, but by-products formed from the reduction reaction should not interfere with the final product when used later in an electrode or an electrochemical cell. One convenient reductant for use to make the mesoporous particles of the invention is a reducing carbon or hydrogen. In that case, any by-product, i.e., carbon monoxide or carbon dioxide (in the case of carbon) or water (in the case of hydrogen), is readily removed from the reaction mixture.

The solvent used in the soft-template synthesis can be selected in such a manner that it allows the formation of micelles from the surfactant that is used to make the mesoporous particles of this invention and also facilitates the formation of LiFePO₄/Li₃V₂(PO₄)₃ nanocrystals from the ionic compounds that are used to make the mesoporous particles. The solvent can be either an inorganic or organic solvent. Examples of a suitable solvent include, but are not limited to, water, methanol, ethanol, propanol, butanol, and hexanol. It can also be a mixture, e.g., a mixture of water and ethanol.

One can heat the mixture containing the starting materials described above to facilitate the formation of LiFePO₄/Li₃V₂(PO₄)₃ nanocrystals. To facilitate this formation, one can also use another method, such as solvothermal (either microwave-assisted or not). See Vadivel Murugan et al., J. Phys. Chem. 112 (2008): 14665-14671.

After the LiFePO₄/Li₃V₂(PO₄)₃ nanocrystals are formed, the solvent is removed so as to collect them. For example, one can evaporate the solvent at an elevated temperature. After the solvent has been removed, the obtained powder can be grounded by a conventional method to break up the agglomeration of the nanocrystals.

The nanocrystals thus obtained can then be sintered at a high temperature, e.g., between 600-800° C., so as to allow the nanocrystals to be closely packed to form particles having a size of micrometers or less, e.g., 50-1000 nm. In the particles, the nanostructures forming the particles are in close contact with their adjacent nanocrystals, forming mesopores having a nano size, e.g., 2-10 nm (the size of a pore is the longest possible distance between two points on the pore). The carbon-containing surfactant on the surface of the nanocrystals is decomposed at the high temperature to form uniform coating of amorphous carbon on the surfaces of the nanocrystals, the average thickness of the coating being about 2-7 nm. The term “uniform coating” refers to coating in which the thickness at the thickest spot is no more than 5 nm greater than that at the thinnest spot.

The above-described sintering step can be conducted under a protective atmosphere. For example, the nanocrystals can be sintered in a tube furnace filled with argon, nitrogen, or other inert gas.

The sintered powder is then cooled, collected, and stored for use in making lithium battery cathodes.

The present invention also provides a battery including an anode, a cathode containing the mesoporous nanostructured particles described above, and a non-aqueous electrolyte between the anode and the cathode.

Each of the anode and cathode includes a current collector for providing electrical communication between the two electrodes and an external load. Each current collector is a foil or grid of an electrically conductive metal such as iron, copper, aluminum, titanium, nickel, or stainless steel, having a thickness of between 5 μm and 100 μm, preferably 5 μm and 20 μm.

The cathode may further include a cathode film having a thickness of between 10 μm and 150 μm, preferably between 25 μm and 125 μm, in order to realize the optimal capacity for the cell. The cathode film contains 80-90% by weight the mesoporous nanostructured particle described above, 1-10% by weight binder, and 1-10% by weight an electrically conductive agent.

Suitable binders include, but are not limited to, polyacrylic acid, carboxymethylcellulose, diacetylcellulose, hydroxypropylcellulose, polyethylene, polypropylene, ethylene-propylene-diene copolymer, polytetrafluoroethylene, polyvinylidene fluoride, styrene-butadiene rubber, tetrafluoroethylene-hexafluoropropylene copolymer, polyvinyl alcohol, polyvinyl chloride, polyvinyl pyrrolidone, tetrafluoroethylene-perfluoroalkylvinyl ether copolymer, vinylidene fluoride-hexafluoropropylene copolymer, vinylidene fluoride-chlorotrifluoroethylene copolymer, ethylenetetrafluoroethylene copolymer, polychlorotrifluoroethylene, vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethylvinyl ether-tetrafluoroethylene copolymer, ethylene-acrylic acid copolymer, ethylene-methacrylic acid copolymer, ethylene-methyl acrylate copolymer, ethylene-methyl methacrylate copolymer, styrene-butadiene rubber, fluorinated rubber, polybutadiene, and mixtures thereof.

Suitable electrically conductive agents include, but are not limited to, natural graphite (e.g. flaky graphite); manufactured graphite; carbon blacks such as acetylene black, Ketzen black, channel black, furnace black, lamp black, and thermal black; conductive fibers such as carbon fibers and metallic fibers; metal powders such as carbon fluoride, copper, and nickel; and organic conductive materials such as polyphenylene derivatives.

The anode can be any conventional anode used in lithium batteries. For example, the anode is an alkali metal foil, such as a lithium metal foil.

An electrolyte provides ionic communication between the cathode and the anode, by transferring ionic charge carriers between the cathode and the anode during the charge and discharge of an electrochemical cell. The electrolyte includes a non-aqueous solvent and an alkali metal salt dissolved therein. Suitable solvents include, but are not limited to, a cyclic carbonate such as ethylene carbonate, propylene carbonate, butylene carbonate or vinylene carbonate, a non-cyclic carbonate such as dimethyl carbonate, diethyl carbonate, ethyl methyl carbonate or dipropyl carbonate, an aliphatic carboxylic acid ester such as methyl formate, methyl acetate, methyl propionate or ethyl propionate, a γ-lactone such as γ-butyrolactone, a non-cyclic ether such as 1,2-dimethoxyethane, 1,2-diethoxyethane or ethoxymethoxyethane, a cyclic ether such as tetrahydrofuran or 2-methyltetrahydrofuran, an organic aprotic solvent such as dimethylsulfoxide, 1,3-dioxolane, formamide, acetamide, dimethylformamide, dioxolane, acetonitrile, propylnitrile, nitromethane, ethyl monoglyme, phospheric acid triester, trimethoxymethane, a dioxolane derivative, sulfolane, methylsulfolane, 1,3-dimethyl-2-imidazolidinone, 3-methyl-2-oxazolidinone a propylene carbonate derivative, a tetrahydrofuran derivative, ethyl ether, 1,3-propanesultone, anisole, dimethylsulfoxide and N-methylpyrrolidone, and mixtures thereof.

The above-described battery can be prepared by a method similar to that described in U.S. application Ser. No. 12/156,644 (Publication NO. US 2009/0305135).

Without further elaboration, it is believed that one skilled in the art can, based on the disclosure herein, utilize the present invention to its fullest extent. The following specific embodiments are, therefore, to be construed as merely descriptive, and not limitative of the remainder of the disclosure in any way whatsoever. All publications cited herein are incorporated by reference.

### Example 1

### Preparation of Li₃V₂(PO₄)₃/C and LiFePO₄/C Particles

All chemical precursors and solvents were commercially available and used as received without further purification unless otherwise stated.

Cetyl trimethylammonium bromide (CTAB), a surfactant, was dissolved in ethanol to give a solution at the concentration of 0.01 M. To prepare LiFePO₄/C particles, LiH₂PO₄ (as lithium and phosphate sources) and FeCl₂.4H₂O or Fe(C₂H₃O₂)₂ were used as ion precursors. The weights of the components used to synthesize LiFePO₄/C are listed in Table 1 below. To prepare Li₃V₂(PO₄)₃/C particles, lithium acetate hydrate, vanadium (IV) oxide bis(2,4-pentanadionate), and ammonium dihydrogen phosphate were used as ion precursors. The weights of the components used to synthesize Li₃V₂(PO₄)₃/C are listed in Table 2 below. The ion precursors were added into the CTAB-ethanol solution. Then, de-ionized water was added to the solution with the ethanol-water volume ratio of 5:1 or 12:1. The solution was stirred for 24 hours and dried using a rotor evaporator at 70° C. After drying, the obtained powder was grounded using a mortar and a pestle. Finally, the ground powder was sintered in a tube furnace under Ar/H₂ atmosphere (for preparing LiFePO₄) or argon atmosphere (for preparing Li₃V₂(PO₄)₃ at 600-800° C. for 4-6 hours.

TABLE 1
The weights and concentrations of the components used to synthesize
LiFePO₄/C:

| Component | Weight |
|---|---|
| CTAB | 3.6446 g |
| LiH₂PO₄ | 0.5227 g |
| FeCl₂•4H₂O | 850 mg |
| or | |
| Fe(C₂H₃O₂)₂ | 850 mg |
| LiH₂PO₄ | 0.5975 g |

TABLE 2
The weights and concentrations of the components used to synthesize
TLi₃V₂(PO₄)₃/C:

| Component | Weight |
|---|---|
| CTAB | 3.6446 g |
| Lithium acetate dehydrate | 0.25 g |
| Vanadium (IV) oxide | 0.4332 g |
| bis(2,4-pentanadionate) | |
| Ammonium dihydrogen | 0.2819 g |
| phosphate | |

### Example 2

### Characterization of Mesoporous Nanostructured Particles

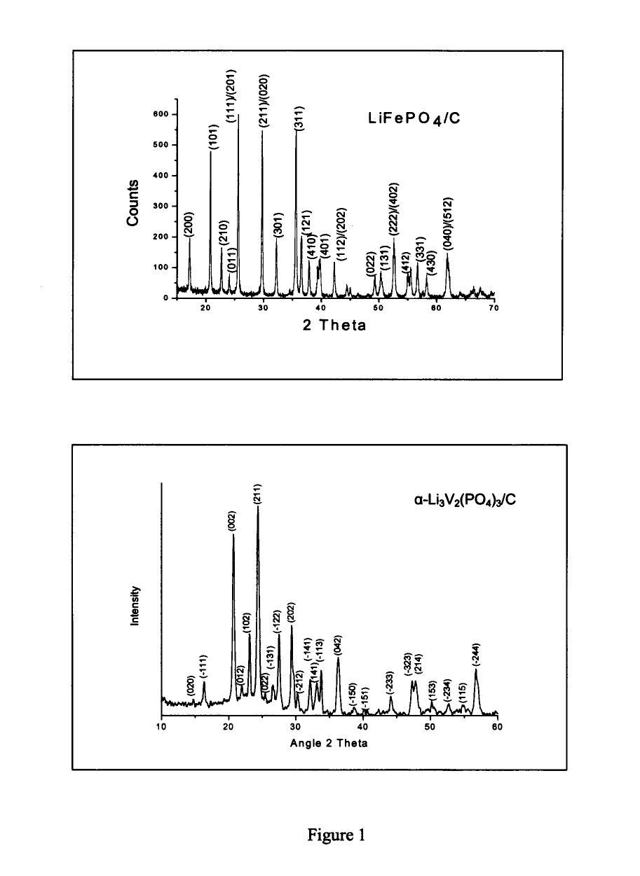

The LiFePO₄/C and Li₃V₂(PO₄)₃/C particles were subjected to X-ray diffraction structural analysis. These studies confirm single phase formation of LiFePO₄ and α-Li₃V₂(PO₄). FIG. 1 shows the diffraction patterns of LiFePO₄ and α-Li₃V₂(PO₄) and the identification of Bragg planes.

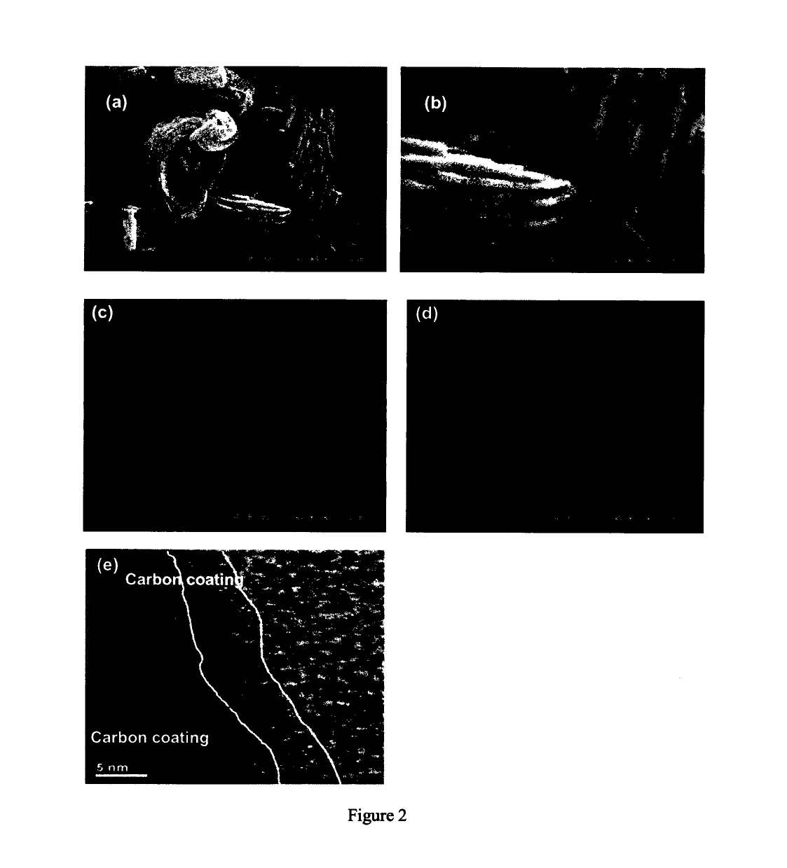

The LiFePO₄/C and Li₃V₂(PO₄)₃/C particles were also subjected to a field emission scanning electron microscopy (FESEM). FIGS. 2(a) and 2(b) are FESEM images of the LiFePO₄/C particles, which show a plate-like morphology with the thickness along b-axis being around 30 nm and a- and c-axes about 30 nm (Pnma space group). Note that spherical morphology was obtained when using chloride based metal precursors. FIGS. 2(c)-(d) are FESEM images of the Li₃V₂(PO₄)₃/C particles, which are spherical. FIG. 2(e) is a high resolution transmission electron microscopy (HRTEM) image of the carbon coating on the surface of Li₃V₂(PO₄)₃. This image shows that the coating has a uniform thickness around 5 nm.

### Example 3

### Electrochemical Properties of LiFePO₄/C and Li₃V₂(PO₄)₃/C Particles

Composite electrodes were fabricated by mixing the LiFePO₄/C or Li₃V₂(PO₄)₃/C particles, super P carbon black, and binder (Kynar 2801) at the weight ratio of 70:15:15 in N-methylpyrrolidone. The electrodes with a thickness of 10 μm and a geometrical area of 2.0 cm² were prepared using an etched aluminum foil as a current collector. A lithium metal foil, 1 M LiPF₆ in ethylene carbonate and diethyl carbonate (1:1 VAT) (Merck), and Celgard 2502 membrane were used as a counter electrode, an electrolyte, and a separator, respectively, to assemble coin-type cells (size 2016) in an Ar-filled glove box (MBraun, Germany). The cells were aged for 12 h before measurement. Charge-discharge cycling at a constant current was carried out using a computer controlled Arbin battery tester (Model, BT2000, USA).

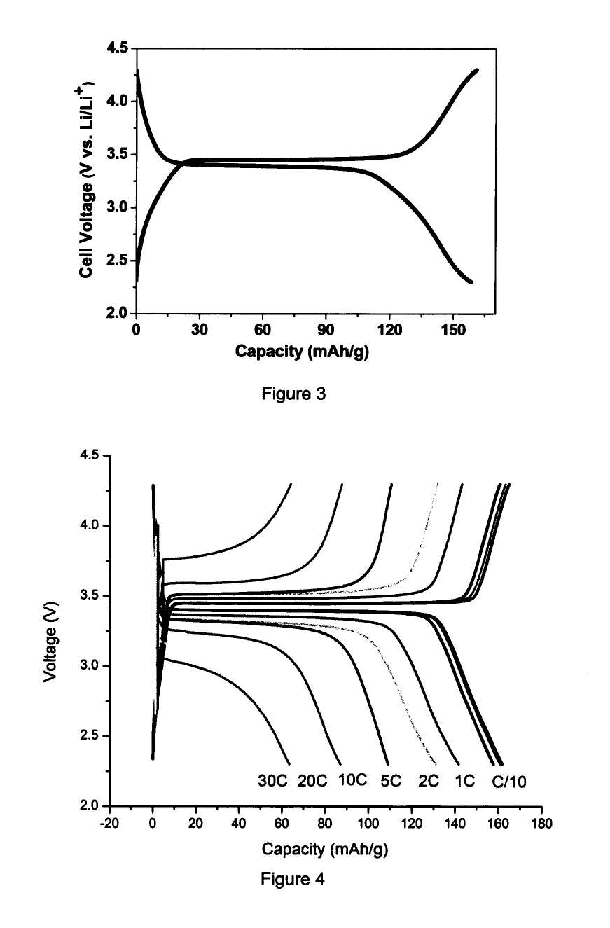

It has been observed that mesoporous LiFePO₄/C particles exhibited excellent storage performance at 2 C rate (1 C refers to removal of 1 Li in one hour resulting in 170 mA). See FIG. 3. At a higher rate of 30 C, the mesoporous LiFePO₄/C particles had a capacity of 58 mAh/g, compared with solvothermally synthesized LiFePO₄ that had only about 45 mAh/g. See FIG. 4.

Electrochemical properties of mesoporous Li₃V₂(PO₄)₃/C particles were also investigated.

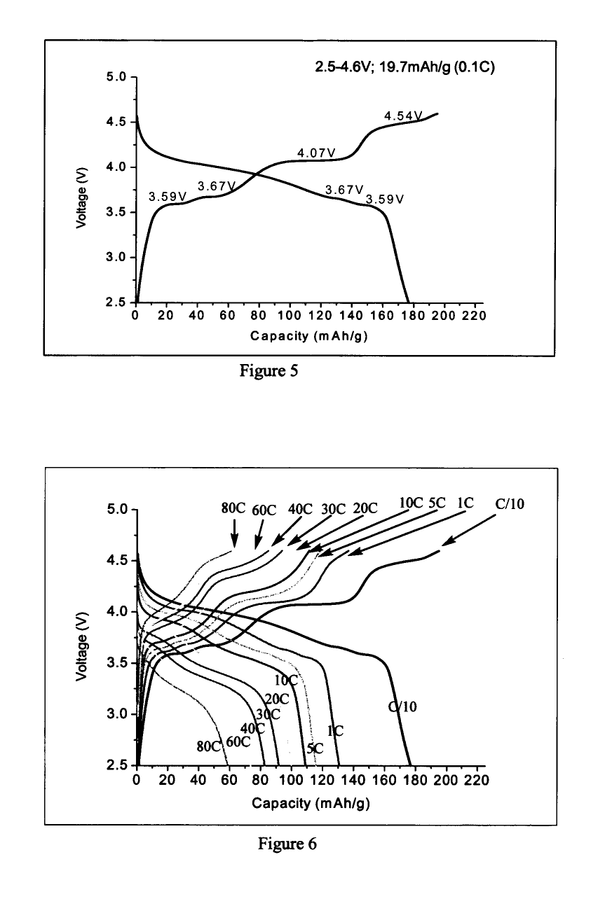

A charge-discharge voltage curve for the synthesized α-Li₃V₂(PO₄)₃ at the rate of C/10 (19.7 mAh/g) in the voltage range of 2.5-4.6 V is shown in FIG. 5. Four charge plateaus at 3.59 V, 3.67 V, 4.07 V and 4.54 V were observed in the charging profile. These plateaus correspond to the phase transition processes of LiₓV₂(PO₄)₃ (x=2.5, 2.0, 1.0, and 0). The sequences of the reactions are showed as below:
3.59 V: Li₃V₂(PO₄)₃→Li_{2.5}V₂(PO₄)₃+0.5Li⁺+0.5e⁻ (charge)
3.67 V: Li_{2.5}V₂(PO₄)₃→Li₂V₂(PO₄)₃+0.5Li⁺+0.5e⁻ (charge)
4.07 V: Li₂V₂(PO₄)₃→LiV₂(PO₄)₃+Li⁺+e⁻ (charge)
4.54 V: LiV₂(PO₄)₃→V₂(PO₄)₃+Li⁺+e⁻ (charge)

The discharge process, on the other hand, gave a S-shaped curve, which indicates the solid solution behavior (V₂(PO₄)₃→Li₂V₂(PO₄)₃) and the two-phase transition behavior at voltage plateaus about 3.67 V (Li₂V₂(PO₄)₃→Li_{2.5}V₂(PO₄)₃) and 3.59 V (Li_{2.5}V₂(PO₄)₃→Li₃V₂(PO₄)₃). The discharge capacity can reach 176.8 mAh/g.

FIG. 6 shows charge-discharge curves of monoclinic α-Li₃V₂(PO₄)₃/C at various C rates (from C/10 to 80 C) in the voltage range of 2.5-4.6 V.

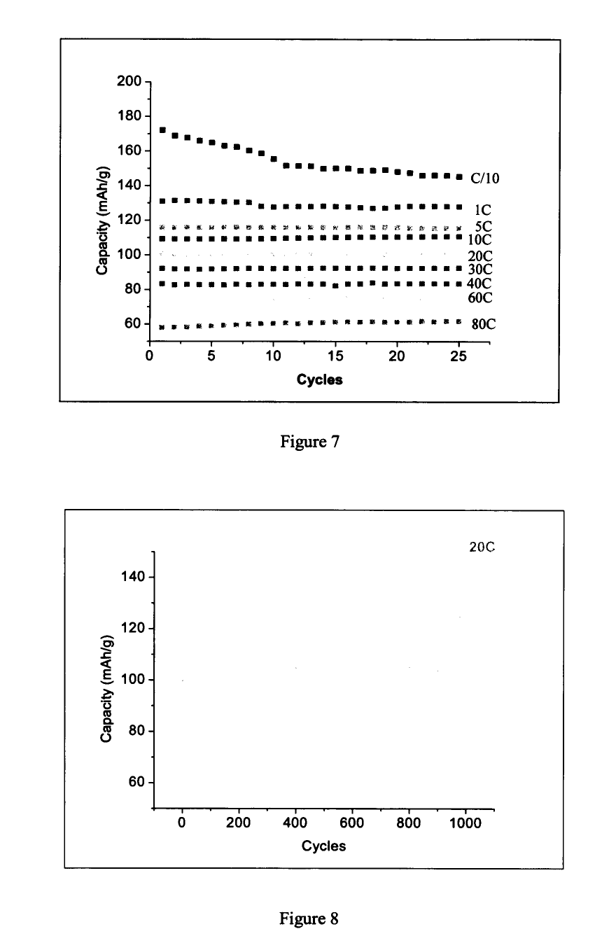

FIG. 7 shows rate performance of α-Li₃V₂(PO₄)₃/C particles versus Li up to 25 cycles in the voltage range of 2.5-4.6 V. At a rate of 80 C, a discharge capacity of 59 mAh/g was achieved with excellent cyclic performance. No significant storage fading was observed.

FIG. 8 shows cyclic performance of α-Li₃V₂(PO₄)₃/C particles versus Li at 20 C up to 1000 cycles in the voltage range of 2.5V-4.6 V. It indicated that the synthesized α-Li₃V₂(PO₄)₃/C particles retained the discharge storage capacity around 102 mAh/g without significant fading up to 1000 cycles.

In summary, the soft-template synthesis possesses several advantages over other methods, such as (a) homogeneous mixing of the reactants avoiding any non-stoichiometry, (b) high degree of crystallinity, (c) control over the size and morphology, (d) in-situ carbon coating on the surface of particulates, and (e) low cost and easy mass production. This soft-template synthesis affords LiFePO₄ and α-Li₃V₂(PO₄)₃ crystallites having small sizes. In addition, this method introduces a thin uniform coating of amorphous carbon (5-7 nm) on the surface of LiFePO₄ and α-Li₃V₂(PO₄)₃ crystallites. These unique structures have led to excellent electrochemical properties of the particles of this invention.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A mesoporous particle comprising
LiFePO₄ or Li₃V₂(PO₄)₃ crystallites, and
uniform coating of amorphous carbon on the surface of each of the crystallites,
wherein each of the crystallites has a size of 20-50 nm and the carbon coating has an average thickness of 2-7 nm, and the crystallites are closely packed together, resulting in mesopores in the particle.

2. The particle of claim 1, wherein the crystallites have a size of 20-30 nm.

3. The particle of claim 1, wherein the particle comprises LiFePO₄ crystallites.

4. The particle of claim 1, wherein the particle comprises Li₃V₂(PO₄)₃ crystallites.

5. The particle of claim 1, wherein the mesopores have a pore size of 2-10 nm.

6. The particle of claim 1, wherein the particle has a diameter of 150-1000 nm.

7. The particle of claim 6, wherein the mesopores have a pore size of 2-10 nm.

8. The particle of claim 7, wherein the particle comprises LiFePO₄ crystallites.

9. The particle of claim 8, wherein the carbon coating on the surface of the crystallites has an average thickness of 5 nm.

10. The particle of claim 7, wherein the particle comprises Li₃V₂(PO₄)₃ crystallites.

11. The particle of claim 10, wherein the carbon coating on the surface of the crystallites has an average thickness of 5 nm.

12. The particle of claim 3, wherein the particle has a diameter of 150-1000 nm.

13. The particle of claim 4, wherein the particle has a diameter of 150-1000 nm.

14. A method of preparing carbon-coated mesoporous metal phosphate particles, comprising
providing a solution containing a carbon-containing soft-template molecule, a lithium ion-containing compound, an iron or vanadium ion-containing compound, a phosphate ion-containing compound, and a solvent, wherein, among the lithium ion-containing compound, the iron or vanadium ion-containing compound, and the phosphate ion-containing compound, two of them are the same compound, all three of them are the same compound, or all three of them are different compounds;
removing the solvent to afford a solid mixture; and
sintering the solid mixture to provide carbon-coated mesoporous metal phosphate particles.

15. The method of claim 14, wherein the soft-template molecule is octyl trimethyl ammonium bromide, decyl trimethyl ammonium bromide, dodecyl trimethyl ammonium bromide, myrsityl trimethyl ammonium bromide, cetyl trimethyl ammonium bromide, trimethyloctadecylammonium chloride, docosyltrimethylammonium chloride, pluronic P-123, pluronic F127, or pluronic F 68.

16. The method of claim 15, wherein the lithium ion-containing compound is lithium acetate dihydrate, lithium dihydrogen phosphate, or lithium hydroxide monohydrate.

17. The method of claim 15, wherein the iron ion-containing compound is iron acetate, iron chloride, or iron acetyl acetonate; and the vanadium ion-containing compound is vanadium (V) oxide, vanadium (III) chloride, vanadium (III) oxide, vanadium (IV) oxide bis(2,4-pentanadionate), vanadium (IV) sulfate oxide hydrate, or vanadium (III) acetylacetonate.

18. The method of claim 15, wherein the phosphate ion containing compound is ammonium dihydrogen phosphate.

19. The method of claim 15, where the lithium ion-containing compound and the phosphate ion containing compound are the same compound that is lithium dihydrogen phosphate.

20. The method of claim 15, wherein the sintering step is conducted at 600-800° C.

21. The method of claim 15, wherein the sintering step is conducted under a protective atmosphere.

22. Mesoporous metal phosphate particles prepared by the method of claim 14.

23. A battery comprising:
an anode,
a cathode,
and a non-aqueous electrolyte between the anode and the cathode,
wherein the cathode contains the particles of claim 1.
